(19) United States
(12) Patent Application Publication
(10) Pub. No.: US 2019/0156962 A1
(43) Pub. Date: May 23, 2019

(54) ELECTROLYTIC TREATMENT FOR NUCLEAR DECONTAMINATION

(71) Applicant: C-TECH INNOVATION LIMITED, Cheshire (GB)

(72) Inventors: John COLLINS, Cheshire (GB); Robert CRAWFORD, Cheshire (GB)

(21) Appl. No.: 16/320,613

(22) PCT Filed: Jul. 25, 2017
(86) PCT No.: PCT/GB2017/052162

§ 371 Date: Jan. 25, 2019

(30) Foreign Application Priority Data
Jul. 26, 2016 (GB) 1612951.2

(51) Int. Cl. G21F 9/00; C25F 1/06; C25F 7/00; G21F 9/06; C23G 1/08

(52) U.S. Cl. CPC G21F 9/004; C25F 1/06; C23G 1/08; G21F 9/06; C25F 7/00

(57) ABSTRACT

A method of removing nuclear contamination from a surface comprising applying a DC-biased AC waveform in an electro-pickling process using nitric acid as the electrolyte.

### TECHNICAL FIELD

This invention relates to the treatment of nuclear contamination especially its removal from surfaces.

### BACKGROUND ART

Decontamination of metal surfaces is a common problem in industry, including in the nuclear industry where metal comes into contact with radionuclides and becomes contaminated. Contaminated metal may include ducting, pipework, glove boxes, storage vessels, mechanical parts such as stirrers etc. Once the metal has been in contact with media containing radioactive species then there remains behind on the surface some residual radioactivity which cannot be removed by simple rinsing or washing, since the radioactive elements have either reacted with the surface or else penetrated a short way into it. There may be some diffusion into the surface, either directly into the surface of the metal and or along cracks propagating into the metal. The result is that there is radioactivity associated with the surface. Radioactive elements include uranium, plutonium and decay products thereof and also radioactive isotopes of other elements that have been exposed to radioactivity.

This is a problem because it makes the handling and disposal of such material hazardous. Operators cannot get close to it, or else they are not able to be near it for long, since proximity contributes to the allowable radiation exposure. Additional precautions and methods and facilities are required therefore to deal with this contamination, with the objectives of containing the contamination, minimising hazard to health, and recovering metal decontaminated metal for re-use via conventional recycling processes.

An additional challenge is that surface contamination is not static—it can change in response to a surface treatment. It is found in some instances that after removal of a contaminated surface layer that the contamination “sweats back”—that is to say that the radioactivity at the surface is reduced after the decontamination treatment but then subsequently increases. This is as a result of diffusion of species from the sub-surface layer to the newly created surface. This underlines the need for having effective control over any decontamination process.

A conventional means to deal with this problem is the physical removal and disposal of the whole item. The obvious drawback to this method is that the volume of contaminated material to be disposed of or stored is larger, and there is no possibility to return any of the material to general use via recycling.

A second means is to use a smelter as described in U.S. Pat. No 5,268,128 A (WESTINGHOUSE) 7-Dec.-93 “Method and apparatus for cleaning contaminated particulate material”, with operating conditions such that the radioactive contamination ends up in the slag, which can be isolated and then stored indefinitely, combined with treatment of the radioactive metal waste using melt decontamination as described in US US2013296629 A (KEPCO NUCLEAR FUEL CO LTD) 7-Nov.-13 and recovering the bulk of the metal as an uncontaminated stream for reuse. This process is operated commercially. The disadvantage of this approach is that a large facility is required, which itself requires extensive control measures.

It is preferable therefore to have a means of decontaminating the material such that the larger part of the metallic base can be recycled without further precaution. This may be applied in-situ, to vessels for example, so that dismantling and decommissioning operations can be carried out with reduced hazard, and it may be applied after dismantling and with the objective of recovering more material for re-use.

The first step in any such process is the removal of any contaminants such as grease or paint. Suitable processes may include the use of solvents to remove greases and the use of abrasive techniques such as grit blasting to remove paint. Laser ablation as described US 2009060780 A (WESTINGHOUSE ELECTRIC GERMANY) 5-Mar-09 “Device & method for the treatment and or decontamination of surfaces” or machining of surfaces may also be used. These methods are effective but are slow and manually intensive processes that generate particulate waste and vapours and therefore present additional hazard control and containment challenges. Solvent based processes have the additional disadvantage that organic material may be introduced that subsequently contaminates the downstream processing and extraction of radionuclides.

Having removed grease and paint a means of removing the surface layer of metal is required. There are various means known.

One method is to chemically dissolve the contaminated layer of metal, including any oxide or other deposited layer. The challenge is to dissolve this contaminated layer completely whilst at the same time dissolving only a finite and controlled amount of the uncontaminated substrate metal. Acid treatments are used for mild steel and stainless steel including 304 stainless steel and also for other materials. Nitric acid is commonly used in the nuclear industry because of the high solubility of the contaminants of interest as nitrates, and also because of the good corrosion resistance of 304 stainless steel to nitric acid. The radioactive contamination is recovered from the nitric acid by standard means including precipitation and flocculation, for example as used in the Enhanced Actinide Removal Plant (EARP) at Sellafield, UK.

Other chemical treatments of metal surfaces are known in the metals finishing industries where thermal processing of metals gives rise to an oxide surface layer which must be removed before further processing steps can be carried out. Various chemical treatments are known including the use of acetic acid (hence the use of the term “pickling”), sulphuric acid and other or additional agents such as hydrochloric acid for mild steel and hydrofluoric acid for stainless steel, or hydrofluoric/nitric acid mixtures. These treatments are not preferred for use in nuclear decontamination because they are incompatible with the stainless steel construction of the downstream effluent treatment plants.

A limitation with the use of nitric acid as a dissolution agent is that the dissolution reaction is slow so that very long treatment times are required. The rate of reaction can be increased through the addition of complexing agents such as chloride, fluoride, and organic complexing agents such as citric acid, oxalic acid and ethylene diamine tetra acetic acid. These agents increase the rate of reaction with the surface contamination but at the expense of creating a liquid which is more corrosive and which cannot be treated using conventional nuclear effluent treatment plant, being corrosive to the metals used in their construction.

A different method of surface decontamination is to use an electrochemical process, for example as disclosed in U.S. Pat. No. 7,384,529 B (US ENERGY) 10-Jun.-08 “Method for electrochemical decontamination of radioactive metal”, where a current is passed through the contaminated article using a conductive electrolyte bath. Electrochemical descaling (or “electro-pickling”) is commonly used in metals processing. This method has the significant advantage over chemical methods in that the rate of surface removal is very much greater than with chemical methods. The practical consequence is that for a given through-put of surface to be decontaminated an electrochemical treatment requires a much smaller quantity of acid reagent than a chemical treatment. An additional advantage is that electrochemical processes are is easily controllable since an electrochemical process responds immediately to the level of current passing which in turn is determined by the electrical potential applied. Electrochemical processes have the significant drawback however in that they are only effective where the geometry allows the placement of the counter-electrode close to the working piece. This is because the electric field and hence the current density decreases quickly with increasing distance from the counter electrode. In the present invention this limitation is referred to as a limited “throwing power” compared to chemical etching methods which act wherever fresh solution comes into contact with metal. “Throwing power” is a term used in the electroplating industry. A good throwing power in an electro-plating process refers to relatively higher rates of electro-plating in areas where the electric field is weak, in comparison with poor throwing power where the rate of deposition is relatively slower in the same areas of weak electric field. In describing this invention “throwing power” is used in the following sense for electro-chemical removal of surface layers: a good throwing power means that the rate of surface removal is relatively high in areas of weak electric field compared to a process with poorer throwing power where the rate of removal in an area of weak electric field is relatively lower.

The choice of electrical waveform for use in electro-pickling has been the subject of previous study and it has been found advantageous to combine a direct current offset to an alternating current waveform principally because this gives a much faster process than either the use of DC current alone or the use of chemical methods. It has been shown in US 2003075456 A (COLLINS ET AL) 24-Apr.-03 that it is possible to descale a wide range of metals coated with oxide films more rapidly using AC waveforms with DC bias, than when using AC waveforms without DC bias. It was also shown that it can be advantageous to periodically reverse the polarity of the DC bias. Removal or cleaning of the oxide layers on the surface of metals was shown to be faster when a DC bias was applied to an AC waveform, compared to the use of AC current alone. The cleaning mechanism involves some dissolution of the contaminated layer, some undercutting where the underlying metal is dissolved, and some scrubbing action resulting from the generation of gas bubbles at the interface.

AC with DC bias allows breakdown of oxide film faster—because in the potential range where dissolution occurs DC current alone leads to either passivation of the surface or oxygen evolution and pitting, whereas AC current alone gives a reduced dissolution effect. AC current with DC bias is found to give the optimum dissolution whilst minimising localised pitting.

Ultrasonic energy may be applied in the electro-pickling process. Ultrasonic energy is known to improve the effectiveness of some electrochemical processes, by a combination of physical effects, including increased rates of diffusion at surfaces and the break-up of solid material close to the surface. Ultrasonic energy is difficult to apply in-situ in all situations however, because of geometrical constraints in locating transducers.

In summary, there are various surface treatment decontamination methods known in the nuclear industry, but none that achieve the desired combination of rapid surface decontamination, good controllability, good throwing power, all whilst retaining the ability to use conventional effluent treatment plants built from 304 stainless steel.

For the nuclear industry it is important to have a rapid and effective process, and one that generates an effluent that can be dealt with subsequently using conventional plant, which is to say that it does not corrode that plant, and in particular the use of chloride or organic anions is avoided.

### DISCLOSURE OF INVENTION

According to the present invention a method removing nuclear contamination from a surface comprising applying a DC-biased AC waveform in an electro-pickling process using nitric acid as the electrolyte.

It has been found surprisingly advantageous to have added a chloride or organic chelating additives to the nitric acid.

One can also include an electrochemical oxidative destruction process. Ideally the electrolyte is recirculated between the electrochemical oxidative destruction process and the electro-pickling process.

Employing these steps in combination achieves good removal rates and throwing power, good controllability of surface removal, and still allows effluent to be treated in a conventional based downstream treatment plant built to handle nitric acid based effluents.

The process described can be used for the decontamination of metals in the nuclear industry with effluent being treated in conventional treatment plants whilst at the same time allowing a greater flexibility of electrolyte composition, including the use of halides and organic metal complexing agents. These contribute to the effectiveness of the surface layer removal and are then themselves destroyed by an oxidative electrochemical reaction.

In the oxidative destruction part of the process, halides are converted to halogens and organic species are converted to carbon dioxide, both of which may be safely removed and disposed of since they are not radioactively contaminated, or only to a very low extent. The radio nucleotides remain in the electrolyte, ready for removal in further process steps such as precipitation and filtration.

Compared to previous processes this process allows rapid surface treatment, with effective control of the system, and allowing the use of conventional effluent treatment plant. The method combines the throwing power and rate enhancement of more corrosive chemical treatments, the high rate of electrochemical removal processes, the effective control of an electrochemical process, and the use of conventional downstream treatment plant for effective separation of contaminated and uncontaminated streams. In particular the added organic species are removed as gaseous carbon dioxide. The combination of electrical waveform type, organic metal complexing agents or halides in nitric acid, and then electrochemical destruction of organic acids achieve this objective.

The system has some or all of the following features:
(a) Recirculation of the electrolyte between the decontamination bath and an electrolytic cell designed to destroy organic metal complexing agents and reduce halides to halogens.
(b) Metal sensing electrodes that monitor the concentration of metallic species in solution at various points.
(c) A control system that adjusts the level of electrical power applied to the decontamination system in response to certain inputs, including the metal concentration sensors and or measured radioactivity.
(d) Regeneration of the electrolyte in a cell designed to convert organic material to carbon dioxide and halides to halogens.

### BRIEF DESCRIPTION OF DRAWINGS

FIG. 1 shows an example of the voltage/time sequence used in this invention;

FIG. 2 shows schematically an example electrode set up used to demonstrate the present invention; and

FIG. 3 illustrates the impact adding hydrochloric acid to nitric acid in an electropickling decontamination process.

### EXPERIMENTAL

Nitric acid is the base electrolyte. This is compatible with standard radio nucleotide recovery plants and does not corrode the materials of construction. Possible additives include hydrochloric acid, various organic acids including citric, oxalic, formic, ethylene diamine tetra acetic acid, other organic metal complexing or chelating agents including those based on nitrogen or phosphorous, as well as glycols and other organic compounds.

The electrical waveform for use in the decontamination process is preferably a DC-biased AC waveform. It is also desirable to have the possibility to reverse the polarity of the DC bias periodically. This has the effect of changing the balance between metal dissolution and hydroxyl ion and hydrogen production, the latter being beneficial for preventing passivation and scrubbing of the surface. The DC bias may optionally be varied in a continuous manner.

A low power waveform may be generated and then fed into a power amplifier, for example a potentiostat. Although the efficiency of such a process can be low (for example as low as 50%) it is a flexible process since any waveform may be specified.

The current density is an important aspect of the invention as it affects the concentration of hydroxyl ions. Hydroxyl ions are important as they help to combat passivation and also hydrogen generation. Greater current densities are beneficial therefore, but only up to a point, since at higher current there is a loss of efficiency due to resistive heating that is proportional to the square of the current. In practice there is an optimum current density. The preferred current density is between 0.1 and 1 amp per square centimetre, and more preferably between 0.4 and 0.7 amps per square centimetre.

The frequency of the AC component of the waveform used may be in the range 1-1000 Hz. The preferred frequency is in the range 5-100 Hz. As frequency increases less of the electrical energy is used in the desired electrochemical conversion, because of the capacitance of the interface, but the alternating current aids removal of passivation via scrubbing and other mechanisms, and in practice a frequency of between 5-100 Hz is preferred. The preferred frequency is dependent on the electrolytes used and also on the composition of the metal surfaces.

The added halide ions or other oxidising additive are removed from the nitric acid solution using a second electrochemical treatment. This consists of a separate electrochemical cell through which the treatment solution is passed. This treatment may be carried out continuously or in a batch-wise process, with multiple paths of the solution through the cell to achieve the desired reduction in levels of halide or other additive.

An electrochemical surface treatment was carried out on test pieces of 304 stainless steel, followed by an electrochemical oxidation process to remove chloride ions. The effectiveness of the treatment was determined by measuring the thickness and weight loss of the sample pieces and by checking that the level of chloride ions in the electrolyte solution after electrochemical oxidation was below the 10 ppm required for subsequent treatment in conventional nuclear effluent treatment plant. The apparatus consisted of an electrical supply to provide a potential between working and counter-electrodes in an electrochemical pickling bath, an electrochemical pickling bath with 304 stainless steel working and counter electrodes, and a separate electrochemical oxidative step to remove additives (chloride ions in this example) from the nitric acid solution.

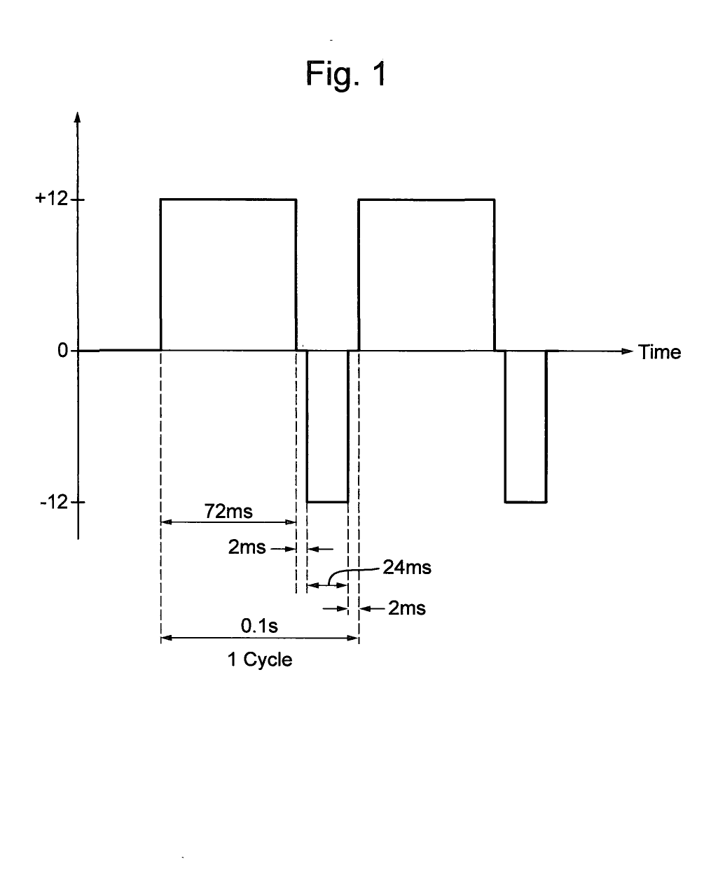

The electrical supply is composed of a driving circuit which creates an electrical waveform, an H bridge circuit which allows for the reversal of polarity of applied potential to form a square wave, and a DC power supply. The applied potential was 12 V and the power supply was capable of supplying 10 A. The frequency used was 10 Hz, though other frequencies may be used. The waveform used is shown in FIG. 1. A single cycle is shown as 72 ms of forward or positive bias, followed by 2 ms of zero potential, followed by 24 ms of negative or reverse bias, followed by 2 ms of zero bias, totalling 100 ms for a 10 Hz supply. The waveform shown has three times longer duration of forward bias than reverse bias and is therefore a DC-biased AC waveform. The 2 ms zero potential periods are provided to ensure reliable operation of the switching circuits and are not important for the electrochemical operation. The 2 ms periods may be reduced or omitted if the electrical circuit can operate robustly without them. The shape and detail of the waveform may be varied. It does not need to be square waves, and alternative waveforms would be suitable, so long as they conform to the constraint of being DC-biased AC waveforms. In this case the bias was positive so that the working electrode was anodically biased, but this need not be the case. The bias may usefully be reversed periodically.

A first experiment, tabulated in table 1 below, shows the very significantly greater rate of surface removal obtained when using an electrochemical process than is obtained when using a chemical process. Two 304 stainless steel coupons of exposed area 3 cm by 3 cm were immersed in a pickling solution that was 3 M in nitric acid and 0.3 M in hydrochloric acid. The rate of loss of metal from the surface of the exposed area was determined by weight loss. Two different treatments were applied. In the first there was no electric potential applied so that the process was a chemical one only. The coupons were exposed for 6 hours and the weight loss measured. In the second treatment the same chemical solution was used but now with the electrical potential applied, with the waveform as described above. The results are given in the table below and show that the electrochemical process gives a rate of removal more two orders of magnitude greater than the chemical process. This finding shows the advantageous rate of surface removal obtained with electrochemical processes compared to chemical processes.

TABLE 1

| | Rate of metal surface loss |
|---|---|
| Treatment applied | (grams per cm² per 24 hours) |
| 0.3M HNO₃ + 0.3M HCl | 0.013 |
| No electrical potential | |
| 6 hours treatment duration | |
| 0.3M HNO3 + 0.3M HCl, | 4.851 |
| 12 V, 10 Hz, 3:1 bias, 0.5 A/cm², | |
| 10 minutes treatment duration | |

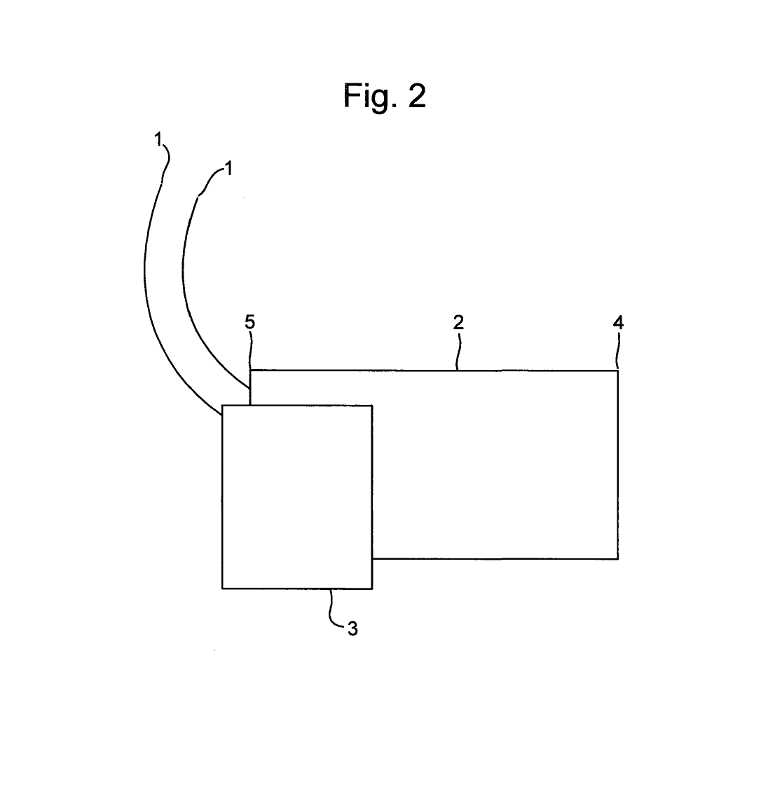

A second experiment shows the different throwing powers obtained with different solution properties when used in electrochemical surface treatments. The arrangement of electrodes is shown in FIG. 2.

The two rectangular electrodes shown are completely submerged in the electrolyte solution. The holding vessel is omitted for clarity. Wires, 1, connect the electrodes to the power supply. A pickling bath of 800 cm³ was used. 1mm thick stainless steel 304 test pieces to form electrodes 2 and 3 were cut to size, each 50 mm wide, parallel to one another and 10 mm apart. The working electrode 2 is the piece representing the object that needs to be decontaminated and is 100 mm long. The counter-electrode 3 is also of 304 stainless steel and is 40 mm long. Suitable materials for the counter-electrode include titanium coated with one of a number of metals and oxides including platinum, platinum oxide, iridium oxide, ruthenium oxide or electrodes composed of carbon composite materials including graphite based materials. The electrical supply to the electrodes is as described above with reference to FIG. 1. Experiments were carried out for a fixed time of ten minutes. After that time the reduction in thickness of the working electrode 2 was measured at intervals along its length. The end of the working electrode that is adjacent to one end of the counter electrode is marked as 5 on FIG. 2, the end of the working electrode furthest from the counter electrode is marked as 4 on FIG. 2. The thickness of the working electrode was measured at ten points one centimetre apart.

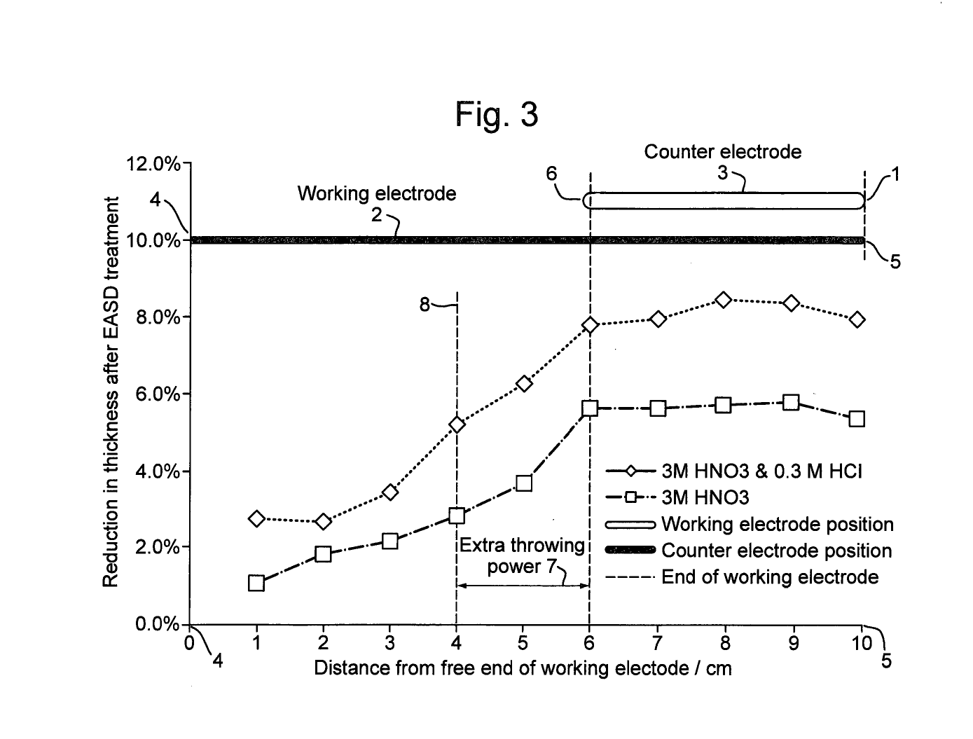

The results are shown in graphical from in FIG. 3. The horizontal axis shows the distance from the end 4 of the working electrode 2 (of FIG. 2). Thus the end 4 is at the origin of the graph labelled 0 cm. The part of the working electrode labelled 5 in FIG. 2 is 10 cms from the end labelled 4 and is shown as the 10 cm mark on the horizontal axis of the graph in FIG. 3. Thus points on the right hand side of the graph correspond to the end of the working electrode near 4 in FIG. 2, the points on the left hand side correspond to the end of the working electrode near 5 in FIG. 2.

The two thick horizontal lines at the top of graph show schematically the relative positions of the working and counter-electrodes. The square points show the effect of an electrochemical process when a nitric acid solution was used. The percentage reduction in thickness of the working electrode is approximately constant at 6% for that part of the working electrode that is parallel to the counter-electrode, and then falls off to a low value further away from the counter-electrode, as is expected. The diamond shaped points show the effect of adding 0.3 M HCl to the solution. There is an overall increase in the thickness loss, equivalent to an increase in the rate of loss. The throwing power 7, shown as the distance between the dashed lines, is effectively increased and this is marked on the graph, showing that reduction in thickness (and rate of material loss) at the 4 cm point 8 in the case with HCl added, is approximately equal to the reduction in thickness at the 6 cm point 6 in the case without HCl. The result of adding the HCl can be seen as extending the effective reach of the electrodes by 2 cm.

In a third experiment the added HCl was removed in a separate electrochemical cell. This cell had the following features. The active electrode areas were 25 cm by 25 cm. The cell was divided using a Nafion cation selective ion exchange membrane (other membrane separators and membranes can be used). The purpose of the ion exchange membrane is to minimises metal deposition on the cathode and prevent parasitic Fe (II)/Fe(III) redox couples arising from the presence of iron ions from the dissolved stainless steel which would otherwise reduce current efficiency. The cathode material was stainless steel which is preferred when treating nitric acid solutions and the anode was titanium coated with a mixture of iridium and tantalum oxides. The cell had a narrow inter-electrode gap of 5 mm and included turbulence promotors in the form of mesh in the electrode gap to give good mass transport and the capability to operate at a high current density. Other inter-electrode spacings are possible depending on the details of the cell construction. The cell was operated with a current density of 0.4 A/cm². The outcome of treating the electrolyte with this cell was an evolution of chlorine gas and a reduction in the concentration of chloride ions from 0.3 M to below 10 ppm (or approximately 3×10⁻⁴ M). This lower level is acceptable for subsequent processing in conventional nuclear effluent treatment plant of 304 stainless steel.

The foregoing show that rapid electrochemical surface removal with good throwing power can be achieved by the use of hydrochloric acid as an additive to nitric acid in an electro-pickling process, and that the chloride ions can be removed subsequently using an electrochemical oxidative step. It has therefore been shown, surprisingly, that a nitric/hydrochloric acid mix can meet all of the objectives required for an nuclear surface decontamination process.

Other embodiments of the invention involve the use of different electrode materials and additives to nitric acid. Possible additives to nitric acid include hydrochloric acid, formic acid, ethylene diamine tetra-acetic acid, and hydrogen peroxide amongst others. Any suitable oxidising agent which can be destroyed electrochemically is suitable. Other anode materials in the oxidative destruction step may be used depending on the added reagent that needs to be removed. Iridium, platinum and ruthenium metal and metal oxide coatings on titanium are suitable for chloride ion removal (chlorine gas evolution) and for the oxidation to carbon dioxide of organic acids such as formic acid, by means of the creation of intermediate oxy-chloride ions. Boron-doped diamond electrodes are also effective at evolving chlorine and generating radical ions for oxidation of organic species. The complete system may optionally use a mixture of anode types. A suitable level of chemical oxygen demand (COD) such that solutions can be processed in 304 stainless steel treatment plants is 10 ppm COD.

1.13. (canceled)

14. A method of removing nuclear contamination from a surface comprising applying an asymmetric alternating current waveform with a net time-averaged current flow in one sense or the other to the surface in an electro-pickling process using nitric acid as the electrolyte in combination with an electrochemical oxidative destruction process, with electrolyte being recirculated between the two processes to create an effluent stream.

15. The method of removing nuclear contamination from a surface according to claim 14 in which the nitric acid has added chloride or organic chelating additives.

16. The method of removing nuclear contamination according to claim 14 in which a current density of between 0.1 and 1 amp inclusive per square centimetre is used.

17. The method of removing nuclear contamination according to claim 16 in which a current density of between 0.4 and 0.7 amps inclusive per square centimetre is used.

18. The method of removing nuclear contamination according to claim 14 wherein the asymmetric is periodically reversed, at a frequency less than that of the frequency of the alternating current waveform.

19. The method of removing nuclear contamination according to claim 14 in which the alternating current frequency is between 1 Hz and 1000 Hz inclusive.

20. The method of removing nuclear contamination according to claim 19 in which the alternating current frequency is between 2 Hz and 500 Hz inclusive.

21. The method of removing nuclear contamination according to claim 19 in which the alternating current frequency is between 5 Hz and 100 Hz inclusive.

22. The method according to claim 14 in which nitric acid has an added chloride or other oxidative species said species being selected from the group containing hydrochloric and hydrofluoric acid, citric acid, oxalic acid, ethylene diamine tetra acetic acid and hydrogen peroxide.

23. The method according to claim 14 employing a counter-electrode comprising or coated with at least one of iridium, platinum, ruthenium and metal oxide coatings on titanium.

24. The method according to claim 14 generating an effluent stream said stream being itreated electrochemically to remove chloride and organic additives.

25. The method according to claim 14 including applying ultrasonic energy to the pickling process.

26. A method of removing nuclear contamination from a surface comprising
applying an asymmetric alternating current waveform with a net time-averaged current flow in one sense or the other to the surface in an electro-pickling process using nitric acid as the electrolyte in combination with an electrochemical oxidative destruction process, with electrolyte being recirculated between the two processes to create an effluent stream in which the nitric acid includes a material selected from the group comprising hydrochloric acid, hydrofluoric acid, oxalic acid, citric acid, ethylene diamine tetra acetic acid, and hydrogen peroxide; in which the current density is between 0.4 and 0.7 amps inclusive per square centimetre and the alternating current frequency is between 5 Hz and 100 Hz inclusive.

27. The method of removing nuclear contamination from a surface according to claim 26 in which the asymmetric bias of the applied alternating current waveform is periodically reversed, at a frequency less than that of the frequency of the alternating current waveform.

28. The method according to claim 26 employing a counter-electrode comprising or coated with at least one of iridium, platinum, ruthenium and metal oxide coatings on titanium.

29. A method of removing nuclear contamination from a surface comprising
applying an asymmetric alternating current waveform with a net time-averaged current flow in one sense or the other to the surface in an electro-pickling process using nitric acid as the electrolyte in combination with an electrochemical oxidative destruction process, with electrolyte being recirculated between the two processes to create an effluent stream in which the nitric acid includes a material selected from the group comprising hydrochloric acid, hydrofluoric acid, oxalic acid, citric acid, ethylene diamine tetra acetic acid, and hydrogen peroxide; in which the current density is between 0.4 and 0.7 amps inclusive per square centimetre and the alternating current frequency is between 5 Hz and 100 Hz inclusive; in which the current density is between 0.4 and 0.7 amps inclusive per square centimetre and the alternating current frequency is between 5 Hz and 100 Hz inclusive; wherein the DC-bias of the applied alternating current waveform is periodically reversed, at a frequency less than that of the frequency of the alternating current waveform and wherein a counter-electrode comprising or coated with at least one of iridium, platinum, ruthenium and metal oxide coatings on titanium is employed.
